(19) United States
(12) Patent Application Publication
(10) Pub. No.: US 2016/0345262 A1
(43) Pub. Date: Nov. 24, 2016

(54) POWER OPTIMIZATION FOR NETWORK BASED INTERNET PROTOCOL FLOW MOBILITY

(71) Applicant: INTEL IP CORPORATION, Santa Clara, CA (US)

(72) Inventors: Puneet K Jain, Hillsboro, OR (US); Vivek Gupta, San Jose, CA (US)

(73) Assignee: Intel Corporation, Santa Clara, CA (US)

(21) Appl. No.: 15/112,080

(22) PCT Filed: Jun. 23, 2015
(86) PCT No.: PCT/US2015/037094

§ 371 Date: Jul. 15, 2016

Related U.S. Application Data
(60) Provisional application No. 62/016,534, filed on Jun. 24, 2014.

(51) Int. Cl. H04W 52/02; H04W 68/02

(52) U.S. Cl. CPC H04W 52/0212; H04W 68/02; H04W 52/0235; H04W 84/042

(57) ABSTRACT

Briefly, in accordance with one or more embodiments, a user equipment (UE) is configured to connect to a network with a multiple access packet data network gateway connection over a wireless wide area network (WWAN) and a wireless local area network (WLAN), enter an idle state for WWAN access, receive a page over the WLAN for WWAN service, connect to the network via the WWAN, and receive the service via the WWAN. A serving gateway (S-GW) is configured to provide a multi-access PDN connection to a UE over a WWAN simultaneously with a WLAN, receive a service to be provided over WWAN access, page the UE via the trusted or untrusted WLAN if the UE is in an idle state, connect with the UE via the WWAN after receiving a response from the UE, and provide the service to the UE via the WWAN.

### CROSS-REFERENCE TO RELATED APPLICATIONS

The present application is a national stage application under 35 U.S.C. §371 of International Application No. PCT/US2015/037094 filed on Jun. 23, 2015. Said application No. PCT/US2015/037094 claims benefit of U.S. Provisional Application No. 62/016,534 filed Jun. 24, 2014 (Docket No. P69671Z). Said Application No. PCT/US2015/037094 and said Application No. 62/016,534 are hereby incorporated herein by reference in their entireties.

### BACKGROUND

Network based internet protocol flow mobility (NB_IFOM) may be utilized by a network to provide a single packet data network connection to user equipment (UE) over multiple accesses simultaneously. Network based internet protocol flow mobility allows one or more internet protocol (IP) flows to be transferred between different access systems while remaining connected to the user equipment. For example, a user equipment may be connected to the network using wireless wide area network (WWAN) access while simultaneously being connected to the network using wireless local area network (WLAN) access. IP flows may be provided to the user equipment via either of the WWAN access or the WLAN access, and furthermore the IP flows may be transferred from one access system to the other access system. The various IP flows may be routed across different access systems according to operator policies, or due to congestion or changes in network conditions, or based on the type of services to be provided and the operator that is able to provide a given type of service. Optimizations of the operation of the user equipment on the network may be provided by taking advantage of the ability to move IP flows among the multiple available access systems seamlessly, without the user experiencing any disruption in service.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a diagram of a network capable of implementing multiple internet protocol flows over a wireless wide area network and wireless local area network in accordance with one or more embodiments;

FIG. 2 is a diagram of the network of FIG. 1 showing additional details of internet protocol flows movable within a public data network connection using a trusted (S2a) connection or an untrusted (S2b) connection in accordance with one or more embodiments;

FIG. 3 is a flow diagram of a method to save power in a user equipment that supports network based internet protocol flow mobility in accordance with one or more embodiments;

FIG. 4 is a diagram of user equipment initiated client based internet protocol flow mobility in accordance with one or more embodiments;

FIG. 5A is a diagram of paging of a wireless local area network for a network based internet protocol flow mobility enabled user equipment showing attach on wireless local area network access in accordance with one or more embodiments;

FIG. 5B is a diagram of paging of a wireless local area network for a network based internet protocol flow mobility enabled user equipment showing paging of the user equipment over the wireless local area network in accordance with one or more embodiments;

FIG. 6 is a block diagram of an information handling system capable of achieving power optimization with network based internet protocol flow mobility in accordance with one or more embodiments; and

FIG. 7 is an isometric view of an information handling system of FIG. 8 that optionally may include a touch screen in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

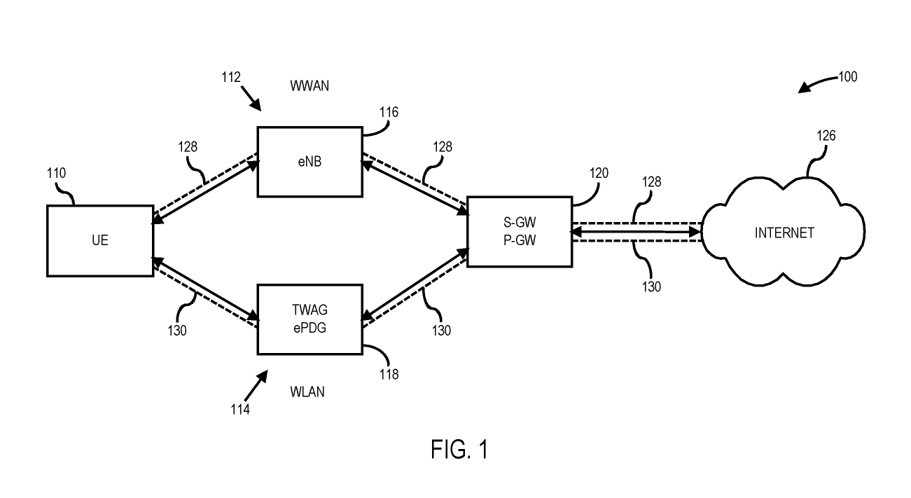

Referring now to FIG. 1, a diagram of a network capable of implementing multiple internet protocol flows over a wireless wide area network and wireless local area network in accordance with one or more embodiments will be discussed. As shown in FIG. 1, network 100 is capable of implementing multiple internet protocol (IP) flows over both wireless wide area network (WWAN) 112 access and wireless local area network (WLAN) 114 access. In such an arrangement, user equipment (UE) 110 may communicate with an evolved Node B (eNB) 116 of WWAN 112 simultaneously with gateway 118 of WLAN 114 such as a Trusted Wireless Access Gateway (TWAG) or an Evolved Packet Data Gateway (ePDG). In one or more embodiments, UE 110 may connect via eNB 116 and/or gateway 118 to core network 120 which may include, for example, a serving gateway (S-GW) 122 and a packet data network gateway (P-GW) or (PDN-GW) to receive data and/or services from network 100 including but not limited to data and/or services received via internet 126, although the scope of the claimed subject matter is not limited in this respect.

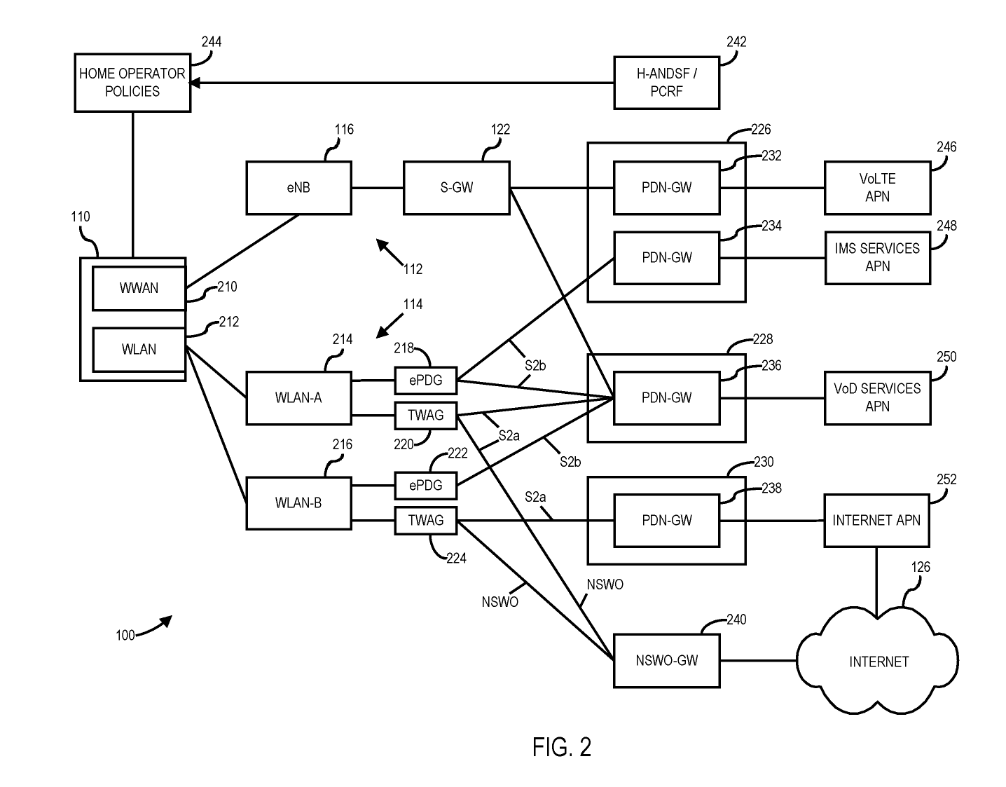

In one or more embodiments, network 100 may implement Network based IP Flow Mobility (NB_IPFOM) in which a single device such as UE 110 has a single packet data network (PDN) connection with network 100 using multiple access simultaneously such as WWAN 112 access and WLAN 114 access. By using NB_IFOM, network 100 is able to transfer one or more IP flows for a single PDN connection with UE 110 between the multiple access devices. For example, a first IP flow 128 may be made to UE 110 via WWAN 112, and a second IP flow 130 may be made to UE 110 via WLAN 114. In response to one or more triggers, the IP flow via one access device may be transferred to another access device for example due network congestion or changes in network conditions. In one or more embodiments as will be discussed in further detail, below, power saving for UE 110 may be obtained by taking advantage of Network Based IP Flow mobility. Further details of how network 100 may implement IP flow mobility is shown in and described with respect FIG. 2, below.

Referring now to FIG. 2, a diagram of the network of FIG. 1 showing additional details of internet protocol flows movable within a public data network connection using a trusted (S2a) connection or an untrusted (S2b) connection in accordance with one or more embodiments will be discussed. As shown in FIG. 2, network 100 may include user equipment (UE) 110 having a wireless wide area (WWAN) modem 210 to connect to network 100 using WWAN 112 access, and a wireless local area network (WLAN) modem 212 to connect to network 100 using WLAN 114 access. WWAN 112 access includes evolved Node B (eNB) 116 and serving gateway (S-GW) 122. In one or more embodiments, WWAN 112 access may be compliant with a Third Generation Partnership Project (3GPP) standard including a Long Term Evolution (LTE) or and Advanced LTE (A-LTE) standard, although the scope of the claimed subject matter is not limited in this respect. Similarly, WLAN 214 includes WLAN routers such as WLAN-A 214 and WLAN-B 216. In one or more embodiments, routers WLAN-A 214 and/or WLAN-B 216 may be in compliance with an Institute of Electrical and Electronics Engineers (IEEE) standard such as IEEE 802.11ac or other IEEE 802.11 standards, and the scope of the claimed subject matter is not limited in this respect. Router WLAN-A 214 may include Evolved Packet Data Gateway (ePDG) 218 and router WLAN-B 216 may include ePDG 222 to provide access via untrusted (S2b) connections. Likewise, router WLAN-A 214 may include Trusted Wireless Access Gateway (TWAG) 220 and router WLAN-B 216 may include TWAG 224 to provide access via trusted (S2a) connections

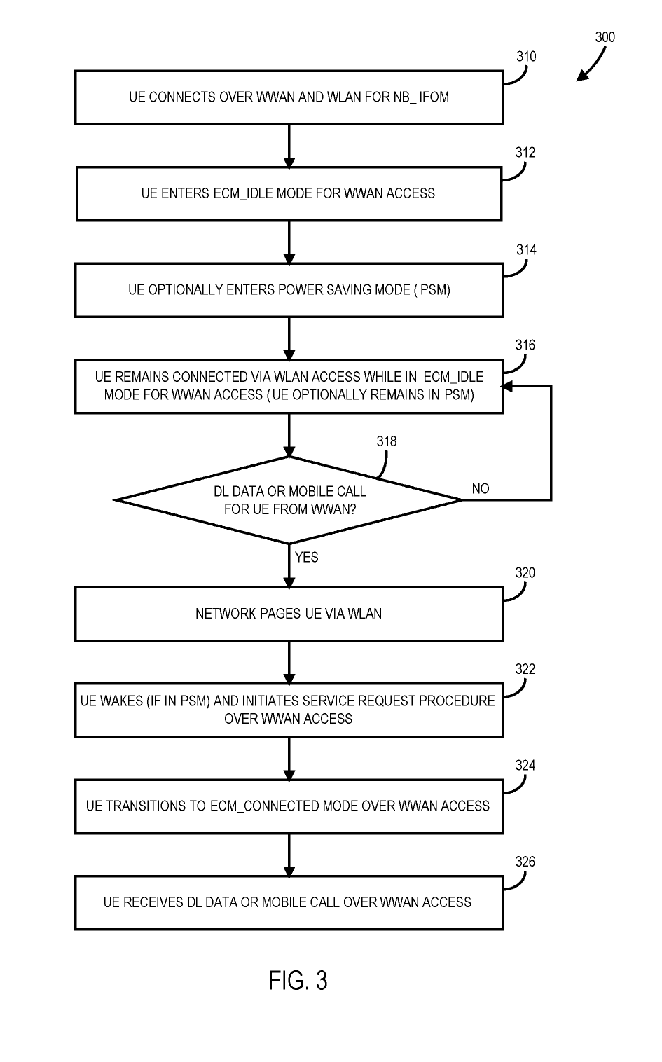

In the embodiment shown in FIG. 2, network 100 may include multiple operators such as operator 226, operator 228, and operator 230. Operator 226 may include packet data network gateway (PDN-GW) 232 and PDN-GW 234. Operator 228 may include PDN-GW 236. Operator 230 may include PDG-GW 238. Network 100 may implement Network based IP Flow Mobility (NB_IPFOM) over multiple access with UE 110. For example, S-GW 122 may couple with PDN-GW 232 of operator 226 and PDN-GW 236 of operator 228 to provide access via WWAN 112. Likewise, ePDG 218 may couple with PDN-GW 234 of operator 226 and PDN-GW 236 of operator 228 to implement provide access via WLAN 114. TWAG 220 may couple with PDN-GW 236 of operator 238 and with Non-Seamless Wireless Local Area Network Offload Gateway (NSWO-GW) 240 via an NSWO connection. In addition, ePDG 222 may couple with PDN-GW 236 of operator 228, and TWAG 224 may couple with PDN-GW 238 of operator 230 and with NSWO-GW 240 via an NSWO connection. NWSO-GW 240 may allow WLAN 114 traffic to be routed directly to and from Internet 126 without passing through a PDN-GW. The operators may provide various IP flows over network 100 by providing various services to UE 110 via network 100. For example, operator 226 may provide Voice over LTE (VoLTE) services via VoLTE Access Point Name (APN) gateway 246 connected with PDN-GW 232. Operator 226 may also provide IP Multimedia Subsystem (IMS) services via IMS Services APN gateway 248 connected PDN-GW 235. Operator 228 may provide Video on Demand (VoD) services via VoD Services APN gateway 250 connected with PDN-GW 236. Operator 230 may provide internet services via Internet APN gateway 252 connected with PDN-GW 238. Internet APN gateway 252 also may be connected with the Internet 126 to provide such internet services. Network 100 also may include a Home Access Network Discovery and Selection Function (H-ANDSF) and Policy and Charging Rules Function (PCRF) server 242 to provide home operator policies 244 to UE 110 for example to assist UE 110 to discover available radio access technologies such as WWAN 112 and WLAN 114 that are available for network 100. A method to allow UE 110 to reduce or otherwise optimize power when connected to network 100 using NB_IPFOM is shown in and described with respect to FIG. 3, below.

Referring now to FIG. 3, a flow diagram of a method to save power in a user equipment that supports network based internet protocol flow mobility in accordance with one or more embodiments will be discussed. Although method 300 of FIG. 3 shows a given number of block in one particular order, in one or more alternative embodiments, method 300 may include more or fewer blocks than shown and/or in various other orders, and the scope of the claimed subject matter is not limited in these respects. In method 300, UE 110 may connect at block 310 over both WWAN 112 access and WLAN 114 access using NB_IPFOM. At block 312, UE 110 may enter an idle mode, such as Evolved Packet System (EPS) Connection Management (ECM) idle mode (ECM_IDLE) according to a 3GPP standard, for WWAN 112 access. Optionally, at block 314, UE 110 may enter into a power saving mode (PSM). At block 316, UE 110 may remain connected via WLAN 114 access while in ECM_IDLE mode for WWAN 112 access, and optionally may remain in PSM. At block 318, a determination may be made whether downlink (DL) data or a mobile call, or some other IP service, for UE 110 is available to be received from WWAN 112. If no such IP service, data, call, or connection is available or otherwise to be received, UE 110 may remain in ECM_IDLE mode or in PSM at block 316. If, however, an IP flow service, data, call, or connection is available or present to be received from WWAN 112, network 100 may page UE 110 via WLAN 114 at block 320. At block 322, if UE 110 is in PSM then UE 110 may wake from PSM, and UE 110 may initiate a service request procedure over WWAN 112 access. At bock 324 UE 110 may then transition to an ECM connected (ECM_CONNECTED) mode over WWAN access 324 to allow UE to receive the DL data, call, connection, or IP service at block 326.

Thus, by implementing method 300 for network 100 and UE 110, power utilization by UE 110 may be reduced or optimized by taking advantage of IP flow Mobility functionality (IFOM) for Proxy Mobile IPv6 (PMIPv6) and/or General Packet Radio Service (GPRS) tunneling protocol (GTP) based S2a (trusted) and S2b (untrusted) connections over WLAN 114 access. Such an arrangement may enable simultaneous support of a single packet data network (PDN) connection over multiple access, or multi-homed access, and may enable transferring one or multiple IP flows belonging to a single PDN connection between different access systems using network based protocols GTP/PMIP. A UE 110 that is NB_IFOM enabled may reduce or optimize power by utilizing the connection over WLAN 114 access to page UE 110 for downlink data to avoid paging the UE 1110 over WWAN 112 or 3GPP access when the WWAN 112 access is in ECM_IDLE mode. In response to an indication received over WLAN 114 access, UE 110 can directly initiate the service request procedure over WWAN 112 or 3GPP access and then transition to ECM_CONNECTED mode.

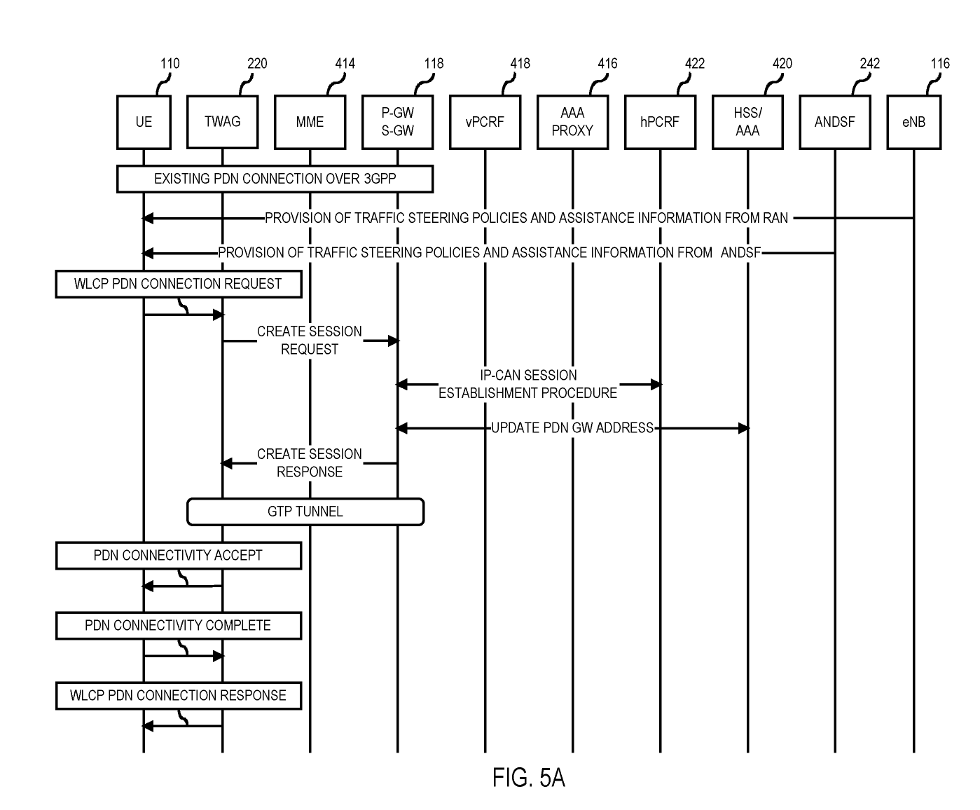

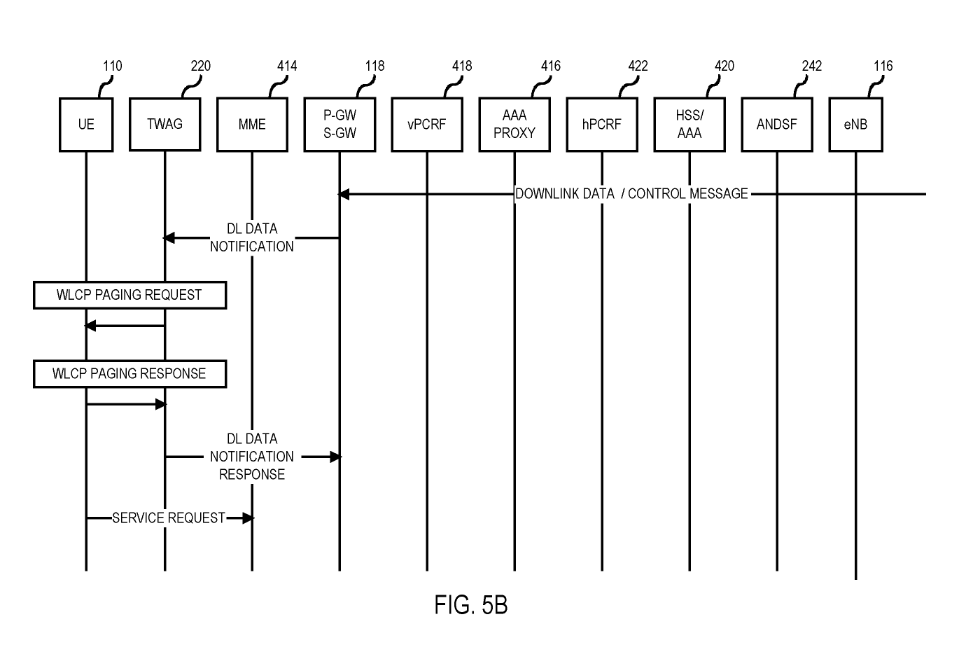

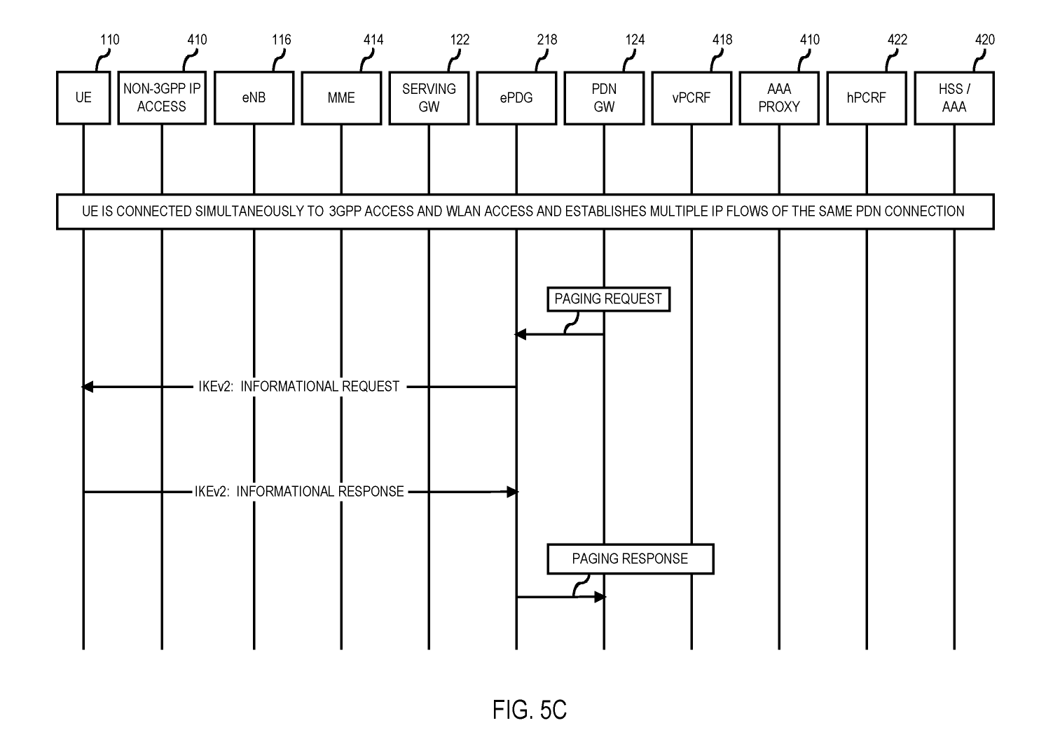

In one or more additional embodiments, further optimization is feasible if UE 110 supports PSM (Power Saving Mode) mode on WWAN 112 or 3GPP access. In such an arrangement, UE 110 will be reachable via WLAN 114 access in case of DL data or mobile terminated calls, and so on. As a result, UE 110 may enter a more power efficient PSM state and stay in a PSM state for longer periods while still being able to be expedited out of PSM state relatively quickly if need, as opposed to waiting for expiry of a PSM timer. Further, the mobility management entity (MME) does not need to buffer any DL data if UE 110 is in a PSM state, and the WWAN 112 or 3GPP system does not need to incur the paging overhead over WWAN 112 or 3GPP access. Such power optimization not only may save UE 110 battery power but also may reduce signaling load in network 100, for example in WWAN 112 or 3GPP access nodes. In some embodiments, paging optimization over WLAN 114 is feasible if UE 110 is NB_IFOM enabled and has a connection over WLAN 114. If the UE 110 does not support NB_IFOM and if there is no connection over WLAN 114, then network 100 optionally may not implement method 300 for that UE 110, but optionally may implement method 300 for other UEs 110 that are NB-IFOM enabled and connected via WLAN 114. Furthermore, if a given UE 110 is NB-IFOM enabled and a given PDN-GW can reach the UE 110, whether or not network 100 implements method 300 may be determined by whether or not UE 110 may be reachable over WLAN 114 via TWAG or ePDG may depend on whether the WLAN 114 access is trusted (S2a) or untrusted (S2b). It should be noted that these are merely examples of how method 300 may be implemented, and the scope of the claimed subject matter is not limited in these respects. A method for UE 110 to initiate client based IP flow mobility is shown in and described with respect to FIG. 5, below.

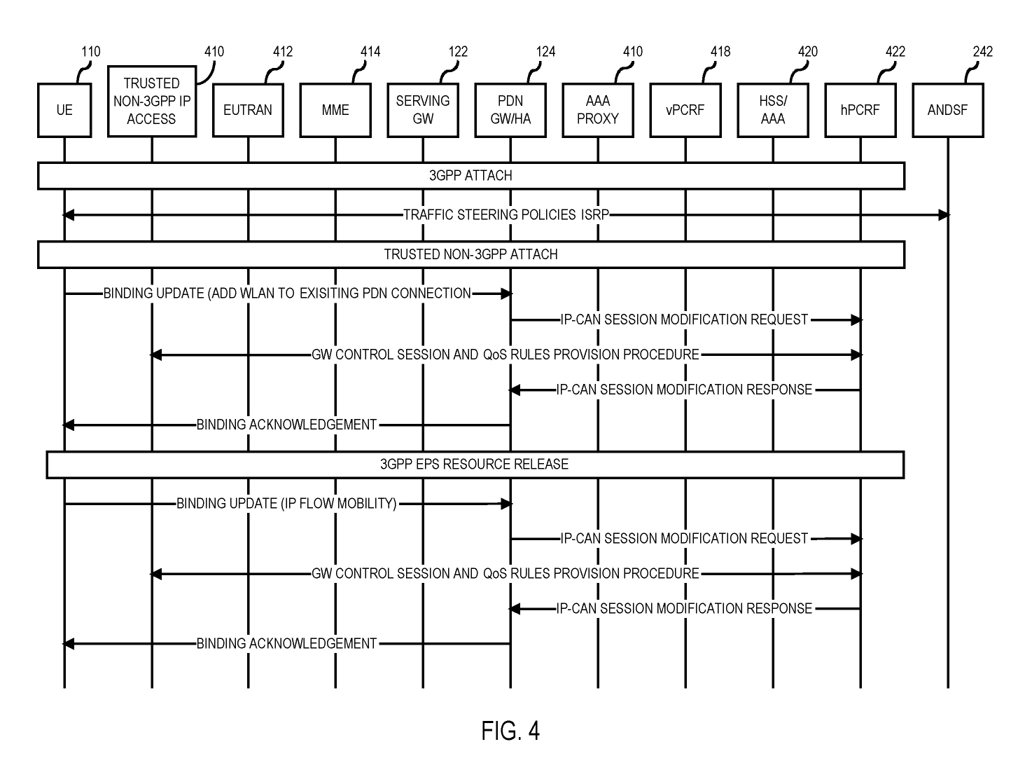

Referring now to FIG. 4, a diagram of user equipment initiated client based internet protocol flow mobility in accordance with one or more embodiments will be discussed. As shown in FIG. 4, various nodes of network 100 may include Trusted Non-3GPP IP Access 410 such as TWAG of TWAG/ePDG 118 of WLAN 114 or TWAG 220 of WLAN-A 214. Network nodes also may include Evolved Universal Mobile Telecommunications System (UMTS) Terrestrial Radio Access Network (EUTRAN) 412, mobility management entity (MME) 414, Authentication, Authorization, and Accounting (AAA) Proxy 416, visited Policy and Charging Rules Function (vPCRF) 418, Home Subscriber Service and Authentication, Authorization, and Accounting (HSS/AAA) server 420, home PCRF (hPCRF) 422, among others. For an NB_IFOM enabled UE 110, when adding WWAN 112 access or non-WWAN access, for example Trusted non-3GPP IP Access 410, to an existing PDN connection, UE 110 provides an indication or establishment cause indicating that the establishment of the PDN connection is for NB_IFOM in order for network 100 to not disconnect the existing PDN connection from the other access. Upon receiving such an indication, PDN-GW 124 establishes and maintains the GTP/PMIP tunnels with both the WWAN 112 (3GPP) access and the non-3GPP access, for example TWAG/ePDG 118. UE 110, however, continues to support power saving states, such as idle mode and PSM, even in this case when there are no IP flows or traffic over WWAN 112 (3GPP) access, although NB_IFOM enabled UE 100 may not be entirely disconnected in this case.

In one or more embodiments, if the inactivity timer at eNB 116 of EUTRAN 412 expires, eNB 116 will release the S1 connection between eNB 116 and UE 110, and UE 110 will go into IDLE mode. If down link data arrives during IDLE mode, then S-GW 122 will not have any downlink General Packet Radio Service (GPRS) Tunneling Protocol (GTP) Tunnel Identifier (DL GTP TEID) for this packet as S1 may be released. In such a case, S-GW 122 will send a downlink data notification (DDN) message to mobility management entity (MME) 414, and MME 414 will page UE 110 over WWAN 112 (3GPP) access by sending a paging message. If the location of UE 110 is not known, UE can be paged in an entire tracking area. This approach, however, may lead to extensive use of signaling resources in the WWAN 112 (3GPP) system. In addition, UE 110 would need to periodically wake-up for listening to the paging channel thereby consuming power resources.

To reduce or optimize such consumption of power resources, for an NB_IFOM enabled UE 110, if there is at least single IP flow over WLAN 114 for a multi-homed PDN connection, WLAN 114 access may be utilized to page the UE 110 instead of using WWAN 112 access to page UE 110. Since the IP flow is established over WLAN 114, a combined and/or co-located S-GW and P-GW 120 knows that UE 110 is reachable over WLAN 114 access based on routing tables, for example by using the same IP address of UE 110 over WWAN 112 (3GPP) and WLAN 114 access. In such an arrangement, combined and/or co-located S-GW P-GW 120 may send the new DDN GTP-C message indicating that there is incoming downlink data for UE 110 over WWAN 112 (3GPP) access. The TWAG of TWAG/ePDG 18 forwards this message to UE 110 using a new Wireless Local Area Network (LAN) Control Plane (WLCP) unicast message which is delivered to UE 110. The protocol stack inside UE 110 after receiving this WLCP message will initiate a Service Request procedure in response to paging over WWAN 112 (3GPP) access. Paging over WLAN 114 access in this scenario may be more efficient than paging the UE 110 over WWAN 112 (3GPP) access. A single unicast message may be sent from the TWAG of TWAG/ePDG 118 to UE 110 in this case.

If no IP flow is established over WLAN 114 access and if UE 110 is unreachable via TWAG, then normal DDN over S11 followed by paging over S1 may be used. Such an optimization provides a realizable benefit for combined and/or co-located S-GW and P-GW 120 deployments. In general, most current deployments have both S-GW 122 and P-GW 124 co-located. Further optimization may be feasible when UE 110 supports PSM mode on WWAN 112 (3GPP) access. In this case, UE 110 will not be reachable via WWAN 1120 (3GPP) access in case of DL data. Network 100 ordinarily would have to wait until the PSM timer expires, and UE 110 would not check for paging messages until then. On the contrary, paging through WLAN 114 access allows UE 110 to terminate the PSM timer and come out of PSM mode and thus respond to the incoming call in an expedited manner, which is able to enhance user experience.

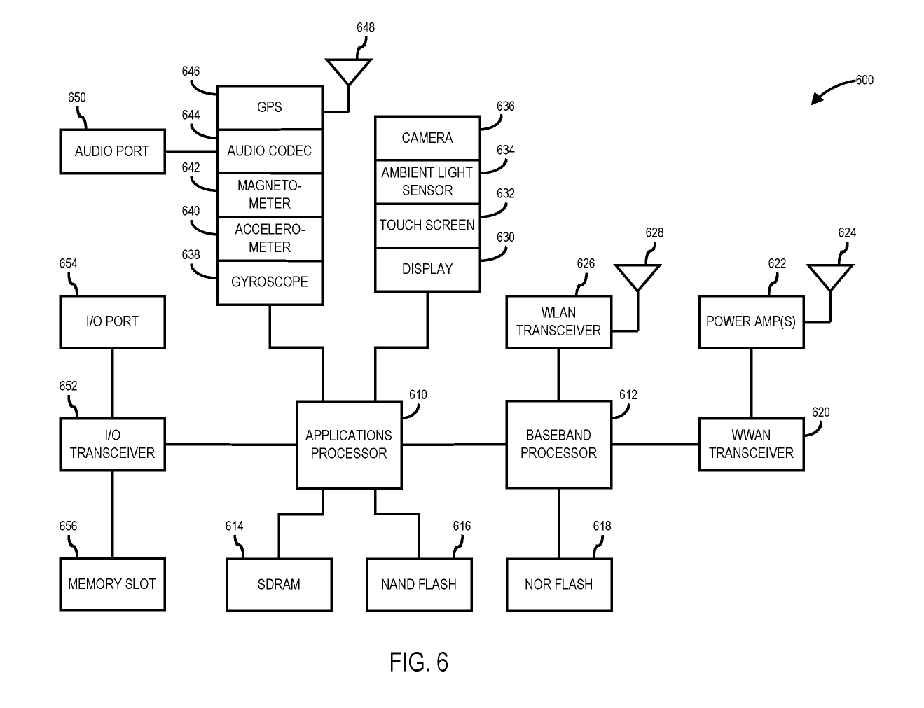

Referring now to FIGS. 5A and 5B, diagrams of attach and paging of a wireless local area network for a network based internet protocol flow mobility enabled user equipment in accordance with one or more embodiments will be discussed. FIG. 6A shows the operations involved in adding WLAN 114 access to an existing PDN connection over WWAN 112 access, and FIG. 6B shows the steps involved in paging an NB_IFOM enabled UE 110 over WLAN 114 access. When using S2a interface for trusted WLAN 114, the WLCP protocol may be be updated and WLCP Paging Request and WLCP Paging Response messages may be added. Similarly, GTP protocol may be updated, and UE Paging Request and UE Paging Response messages may be added. If in case the paging of UE 110 over WLAN 114 fails for any reason, network 100 may revert to a default scenario of paging over WWAN 112 (3GPP) access. When using an S2b interface for untrusted WLAN 114, the paging notification messages may be, for example, based on Internet Keying version 2 (IKEv2) signaling as shown in and described with respect to FIG. 5C, below.

In FIG. 5B, when S-GW and P-GW 118 receives a downlink data packet and/or control signaling for UE 110 known as not user plane connected, that is the S-GW 122 context data indicates no downlink user plane TEID, S-GW and P-GW 120 buffers the downlink data packet and identifies if UE 110 has another flow belonging to same PDN connection, that is whether UE 110 has a multi-homed PDN connection. If UE 110 does have another flow, then S-GW 122 sends a DL Data notification to TWAG 220 for paging UE 110. In one or more embodiments, a different or new GTP message may be used for this purpose. For a Proxy Mobile IPv6 (PMIPv6) based S2a connection, the same message or a different PMIPv6 message may be utilized.

In one or more embodiments, a WLCP Paging Request and a WLCP Paging Response may be optionally may be utilized, as UE 110 is capable of directly responding with a service request as shown in FIG. 5B. If combined or co-located S-GW and P-GW 118 does not receive a DDN response or failure, S-GW and P-GW 118 may try an S1 paging procedure over WWAN 112 (3GPP) access. Such a service request may occur any time after execution of a WLCP Paging Request. In some embodiments, a similar approach may be implemented for Multiple Access PDN Connectivity (MAPCON) situations where UE 110 has two separate PDN connections over WWAN 112 (3GPP) access and WLAN 114 access. For S2a connections, a single mode connection WLCP may not be used between UE 110 and TWAG 220 so a new protocol or message may be provided. It is noted that these are merely examples of multiple access IP flows that may be utilized to achieve power saving or optimization for UE 110 connected with network 100, and the scope of the claimed subject matter is not limited in these respects.

Referring now to FIG. 5C, a flow diagram of Internet Keying version 2 (IKEv2) based paging for untrusted wireless local area network (WLAN) access using an Evolved Packet Data Gateway (ePDG) in accordance with one or more embodiments will be discussed. As shown in FIG. 5C, ePDG 218 may initiate an IKEv2 INFORMATIONAL request, which includes the paging request to UE 110. The protocol stack inside UE 110 after receiving this Paging Request message will initiate a Service Request procedure in response to paging over wireless wide area network (WWAN) 114 or 3GPP access. In response, UE 110 sends an IKEv2 INFORMATIONAL response, acknowledging the paging request and specifying an appropriate paging response, although the scope of the claimed subject matter is not limited in these respects.

Referring now to FIG. 6, a block diagram of an information handling system capable of achieving power optimization with network based internet protocol flow mobility in accordance with one or more embodiments will be discussed. Information handling system 600 of FIG. 6 may tangibly embody any one or more of the elements described herein, above, including but not limited to, for example, UE 110, eNB 116, TWAG and/or ePDG 118, S-GW 122, P-GW 124, combined S-GW and P-GW 120, and so on, with greater or fewer components depending on the hardware specifications of the particular device. Although information handling system 600 represents one example of several types of computing platforms, information handling system 600 may include more or fewer elements and/or different arrangements of elements than shown in FIG. 6, and the scope of the claimed subject matter is not limited in these respects.

In one or more embodiments, information handling system 600 may include an application processor 610 and a baseband processor 612. Application processor 610 may be utilized as a general-purpose processor to run applications and the various subsystems for information handling system 600. Application processor 610 may include a single core or alternatively may include multiple processing cores wherein one or more of the cores may comprise a digital signal processor or digital signal processing (DSP) core. Furthermore, application processor 610 may include a graphics processor or coprocessor disposed on the same chip, or alternatively a graphics processor coupled to application processor 610 may comprise a separate, discrete graphics chip. Application processor 610 may include on board memory such as cache memory, and further may be coupled to external memory devices such as synchronous dynamic random access memory (SDRAM) 614 for storing and/or executing applications during operation, and NAND flash 616 for storing applications and/or data even when information handling system 600 is powered off. In one or more embodiments, instructions to operate or configure the information handling system 600 and/or any of its components or subsystems to operate in a manner as described herein may be stored on a article of manufacture comprising a non-transitory storage medium. In one or more embodiments, the storage medium may comprise any of the memory devices shown in and described herein, although the scope of the claimed subject matter is not limited in this respect. Baseband processor 612 may control the broadband radio functions for information handling system 600. Baseband processor 612 may store code for controlling such broadband radio functions in a NOR flash 618. Baseband processor 612 controls a wireless wide area network (WWAN) transceiver 620 which is used for modulating and/or demodulating broadband network signals, for example for communicating via a 3GPP LTE or LTE-Advanced network or the like. In one or more embodiments, SDRAM 614, NAND Flash 716, and/or NOR Flash 718 may comprise an article of manufacture comprising a non-transitory storage medium having code stored thereon such as software, firmware, or logic circuits, to cause a machine, processor, computing device or computer to implement any method or system as discussed herein.

In general, WWAN transceiver 620 may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, and/or general telemetry transceivers, and in general any type of RF circuit or RFI sensitive circuit. It should be noted that such standards may evolve over time, and/or new standards may be promulgated, and the scope of the claimed subject matter is not limited in this respect.

The WWAN transceiver 620 couples to one or more power amps 642 respectively coupled to one or more antennas 624 for sending and receiving radio-frequency signals via the WWAN broadband network. The baseband processor 612 also may control a wireless local area network (WLAN) transceiver 626 coupled to one or more suitable antennas 628 and which may be capable of communicating via a Wi-Fi, Bluetooth®, and/or an amplitude modulation (AM) or frequency modulation (FM) radio standard including an IEEE 802.11 a/b/g/n standard, and IEEE 802.11ac standard, or the like. It should be noted that these are merely example implementations for application processor 610 and baseband processor 612, and the scope of the claimed subject matter is not limited in these respects. For example, any one or more of SDRAM 614, NAND flash 616 and/or NOR flash 618 may comprise other types of memory technology such as magnetic memory, chalcogenide memory, phase change memory, or ovonic memory, and so on, and the scope of the claimed subject matter is not limited in this respect.

In one or more embodiments, application processor 610 may drive a display 630 for displaying various information or data, and may further receive touch input from a user via a touch screen 632 for example via a finger or a stylus. An ambient light sensor 634 may be utilized to detect an amount of ambient light in which information handling system 600 is operating, for example to control a brightness or contrast value for display 630 as a function of the intensity of ambient light detected by ambient light sensor 634. One or more cameras 636 may be utilized to capture images that are processed by application processor 610 and/or at least temporarily stored in NAND flash 616. Furthermore, application processor may couple to a gyroscope 638, accelerometer 640, magnetometer 642, audio coder/decoder (CODEC) 644, and/or global positioning system (GPS) controller 646 coupled to an appropriate GPS antenna 648, for detection of various environmental properties including location, movement, and/or orientation of information handling system 600. Alternatively, controller 646 may comprise a Global Navigation Satellite System (GNSS) controller. Audio CODEC 644 may be coupled to one or more audio ports 650 to provide microphone input and speaker outputs either via internal devices and/or via external devices coupled to information handling system via the audio ports 650, for example via a headphone and microphone jack. In addition, application processor 610 may couple to one or more input/output (I/O) transceivers 652 to couple to one or more I/O ports 654 such as a universal serial bus (USB) port, a high-definition multimedia interface (HDMI) port, a serial port, and so on. Furthermore, one or more of the I/O transceivers 652 may couple to one or more memory slots 656 for optional removable memory such as secure digital (SD) card or a subscriber identity module (SIM) card, although the scope of the claimed subject matter is not limited in these respects.

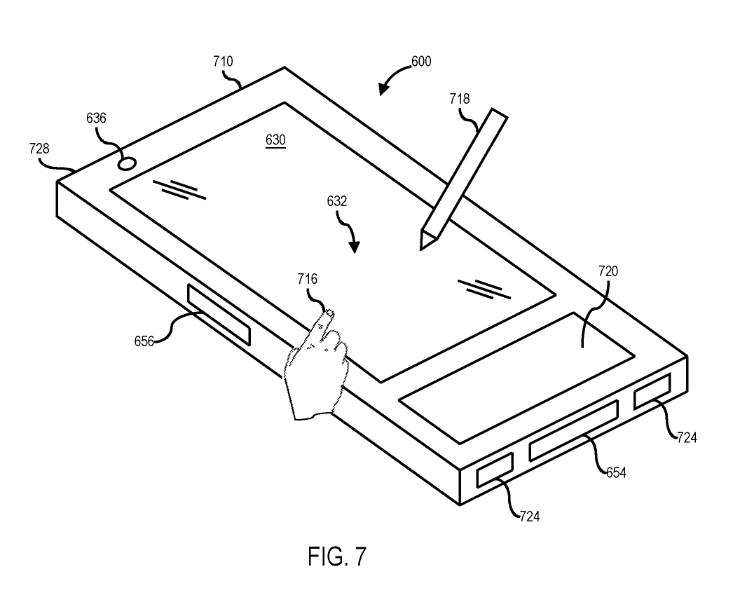

FIG. 7 is an isometric view of an information handling system of FIG. 6 that optionally may include a touch screen in accordance with one or more embodiments. FIG. 7 shows an example implementation of information handling system 600 of FIG. 6 tangibly embodied as a cellular telephone, smartphone, or tablet type device or the like, for example as an example embodiment of UE 110 or similar device. The information handling system 600 may comprise a housing 710 having a display 630 which may include a touch screen 632 for receiving tactile input control and commands via a finger 716 of a user and/or a via stylus 718 to control one or more application processors 610. The housing 710 may house one or more components of information handling system 600, for example one or more application processors 610, one or more of SDRAM 614, NAND flash 616, NOR flash 618, baseband processor 612, and/or WWAN transceiver 620. The information handling system 600 further may optionally include a physical actuator area 720 which may comprise a keyboard or buttons for controlling information handling system via one or more buttons or switches. The information handling system 600 may also include a memory port or slot 656 for receiving non-volatile memory such as flash memory, for example in the form of a secure digital (SD) card or a subscriber identity module (SIM) card. Optionally, the information handling system 600 may further include one or more speakers and/or microphones 724 and a connection port 654 for connecting the information handling system 600 to another electronic device, dock, display, battery charger, and so on. In addition, information handling system 600 may include a headphone or speaker jack 728 and one or more cameras 636 on one or more sides of the housing 710. It should be noted that the information handling system 600 of FIG. 7 may include more or fewer elements than shown, in various arrangements, and the scope of the claimed subject matter is not limited in this respect.

In non-limiting example embodiments, user equipment (UE) comprises processing circuitry to connect to a network with a multi-access single packet data network connection over a wireless wide area network (WWAN) and a wireless local area network (WLAN) enter an idle state for WWAN access, receive a page over the WLAN while in the IDLE state or power saving mode (PSM) activated for WWAN access, wherein the page is for service via the WWAN, connect to the network via the WWAN, and receive the service via the WWAN. The WWAN comprises a Third Generation Partnership Project (3GPP) network. The idle state comprises an ECM_IDLE state or wherein the UE has activated Power Saving Mode. In order to connect to the network via the WWAN, the processing circuitry is configured to initiate a service request procedure over the WWAN, and transition to an ECM_CONNECTED mode over the WWAN. The processing circuitry is configured to activate power saving mode, and wake the User Equipment in response to receiving the page over the WLAN while the power saving mode is activated. The service via the WWAN comprises downlink data, a mobile call, or an internet service, or a combination thereof. The user equipment is capable of operating via network based internet protocol flow mobility with the network using a single multi-access packet data network (PDN) connection.

In other non-limiting example embodiments, a serving gateway (S-GW) comprises processing circuitry to provide a connection to user equipment (UE) over a wireless wide area network (WWAN) simultaneously with a wireless local area network (WLAN) connected to the user equipment as a single packet data network connection, receive a service to be provided to the user equipment over WWAN access, page the user equipment via the WLAN if the user equipment is in an idle state or power saving mode (PSM) has been activated for the WWAN, connect with the user equipment via the WWAN after receiving a response from the user equipment, and provide the service to the user equipment via the WWAN. The WWAN comprises a Third Generation Partnership Project (3GPP) network. The serving gateway is co-located with a packet data network gateway (P-GW), and the processing circuitry of the gateway is configured to send the page to the user equipment via the packet data network gateway. In order to page the user equipment, the processing circuitry is configured to cause a paging request being sent to a Trusted Wireless Access Gateway (TWAG) and the TWAG is configured to send a Wireless Local Area Network (LAN) Control Plane (WLCP) paging request to be sent to the user equipment and to receive a WLCP paging response from the user equipment. In order to page the user equipment, the processing circuitry is configured to cause a paging request being sent to an Evolved Packet Data Gateway (ePDG), and the ePDG is configured to send an IKEv2 INFORMATIONAL Request which includes a paging request message to be sent to the user equipment and to receive a IKEv2 INFORMATIONAL Response which includes a paging response message from the user equipment. In order to page the user equipment, the processing circuitry is configured to send a notification to a trusted wireless access gateway (TWAG) or an Evolved Packet Data Gateway (ePDG) of the WLAN and to receive a notification response back from the trusted wireless access gateway. The response received from the user equipment comprises a service request for WWAN access. The service to be provided to the user equipment via the WWAN comprises downlink data, a mobile call, or an internet service, or a combination thereof. The processing circuitry is configured to otherwise page the user equipment via the WWAN if the user equipment is not capable of operating via network based internet protocol flow mobility with the network. The processing circuitry is configured to otherwise page the user equipment via the WWAN if the user equipment is not connected to the WLAN when the service to be provided to the user equipment is received.

In additional non-limiting example embodiments, a non-transitory storage medium comprises instructions that, if executed by a processor, result in a user equipment connecting to a network with a single packet data network connection over a wireless wide area network (WWAN) and a wireless local area network (WLAN), entering an idle state for WWAN access, receiving a page over the WLAN while in the IDLE state for WWAN access, wherein the page is for service via the WWAN, connecting to the network via the WWAN, and receiving the service via the WAN. The WWAN comprises a Third Generation Partnership Project (3GPP) network. The idle state comprises an ECM_IDLE state. In order to connect to the network via the WWAN, the instructions, if executed by the processor, further result in the user equipment initiating a service request procedure over the WWAN, and transitioning to an ECM_CONNECTED mode over the WWAN. The instructions, if executed by the processor, further result in the user equipment entering into a power saving mode, and waking in response to receiving the page over the WLAN while in the power saving mode. The service via the WWAN comprises downlink data, a mobile call, or an internet service, or a combination thereof. The instructions, if executed by the processor, result in the user equipment operating via network based internet protocol flow mobility with the network.

In further non-limiting example embodiments, an article of manufacture comprises a non-transitory storage medium having instructions thereon that, if executed, result in a serving gateway providing a connection to user equipment (UE) over a wireless wide area network (WWAN) simultaneously with a wireless local area network (WLAN) connected to the user equipment as a single packet data network connection, receiving a service to be provided to the user equipment over WWAN access, paging the user equipment via the WLAN if the user equipment is in an idle state for the WWAN, connecting with the user equipment via the WWAN after receiving a response from the user equipment, and providing the service to the user equipment via the WWAN. The WWAN comprise a Third Generation Partnership Project (3GPP) network. The serving gateway is co-located with a packet data network gateway (P-GW), and the instructions, if executed, result in the gateway sending the page to the user equipment via the packet data network gateway. In order to page the user equipment, the instructions, if executed, result in the serving gateway causing a Wireless Local Area Network (LAN) Control Plane (WLCP) paging request to be sent to the user equipment and to receive a WLCP paging response from the user equipment. In order to page the user equipment, the instructions, if executed, result in the serving gateway causing an IKEv2 INFORMATIONAL Request which includes a paging request to be sent to the user equipment and to receive a IKEv2 INFORMATIONAL Response which includes a paging response from the user equipment. In order to page the user equipment, the instructions, if executed, result in the serving gateway sending a notification to a trusted wireless access gateway (TWAG) of the WLAN and to receive a notification response back from the trusted wireless access gateway. The response received from the user equipment comprises a service request for WWAN access. The service to be provided to the user equipment via the WWAN comprises downlink data, a mobile call, or an internet service, or a combination thereof. The instructions, if executed, result in the serving gateway otherwise paging the user equipment via the WWAN if the user equipment is not capable of operating via network based internet protocol flow mobility with the network. The instructions, if executed, result in the serving gateway otherwise paging the user equipment via the WWAN if the user equipment is not connected to the WLAN when the service to be provided to the user equipment is received.

Although the claimed subject matter has been described with a certain degree of particularity, it should be recognized that elements thereof may be altered by persons skilled in the art without departing from the spirit and/or scope of claimed subject matter. It is believed that the subject matter pertaining to power optimization for network based internet protocol flow mobility and many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. User equipment (UE), comprising processing circuitry to:
connect to a network with a multi-access single packet data network connection over a wireless wide area network (WWAN) and a wireless local area network (WLAN);
enter an idle state for WWAN access;
receive a page over the WLAN while in the IDLE state or power saving mode (PSM) activated for WWAN access, wherein the page is for service via the WWAN;
connect to the network via the WWAN; and
receive the service via the WWAN.

2. User equipment as claimed in claim 1, wherein the WWAN comprises a Third Generation Partnership Project (3GPP) network.

3. User equipment as claimed in claim 1, wherein the idle state comprises an ECM_IDLE state or wherein the UE has activated Power Saving Mode.

4. User equipment as claimed in claim 1, wherein in order to connect to the network via the WWAN, the processing circuitry is configured to:
initiate a service request procedure over the WWAN; and
transition to an ECM_CONNECTED mode over the WWAN.

5. User equipment as claimed in claim 1, wherein the processing circuitry is configured to:
activate power saving mode; and
wake the User Equipment in response to receiving the page over the WLAN while the power saving mode is activated.

6. User equipment as claimed in claim 1, wherein the service via the WWAN comprises downlink data, a mobile call, or an internet service, or a combination thereof.

7. User equipment as claimed in claim 1, wherein the user equipment is capable of operating via network based internet protocol flow mobility with the network using a single multi-access packet data network (PDN) connection.

8. A serving gateway (S-GW), comprising processing circuitry to:
provide a connection to user equipment (UE) over a wireless wide area network (WWAN) simultaneously with a wireless local area network (WLAN) connected to the user equipment as a single packet data network connection;
receive a service to be provided to the user equipment over WWAN access;
page the user equipment via the WLAN if the user equipment is in an idle state or power saving mode (PSM) has been activated for the WWAN;
connect with the user equipment via the WWAN after receiving a response from the user equipment; and
provide the service to the user equipment via the WWAN.

9. The serving gateway as claimed in claim 8, wherein the WWAN comprises a Third Generation Partnership Project (3GPP) network.

10. The serving gateway as claimed in claim 8, wherein the serving gateway is co-located with a packet data network gateway (P-GW), and the processing circuitry of the gateway is configured to send the page to the user equipment via the packet data network gateway.

11. The serving gateway as claimed in claim 8, wherein in order to page the user equipment, the processing circuitry is configured to cause a paging request being sent to a Trusted Wireless Access Gateway (TWAG) and the TWAG is configured to send a Wireless Local Area Network (LAN) Control Plane (WLCP) paging request to be sent to the user equipment and to receive a WLCP paging response from the user equipment.

12. The serving gateway as claimed in claim 8, wherein in order to page the user equipment, the processing circuitry is configured to cause a paging request being sent to an Evolved Packet Data Gateway (ePDG), and the ePDG is configured to send an IKEv2 INFORMATIONAL Request which includes a paging request message to be sent to the user equipment and to receive a IKEv2 INFORMATIONAL Response which includes a paging response message from the user equipment.

13. The serving gateway as claimed in claim 8, wherein in order to page the user equipment, the processing circuitry is configured to send a notification to a trusted wireless access gateway (TWAG) or an Evolved Packet Data Gateway (ePDG) of the WLAN and to receive a notification response back from the trusted wireless access gateway.

14. The serving gateway as claimed in claim 8, wherein the response received from the user equipment comprises a service request for WWAN access.

15. The serving gateway as claimed in claim 8, wherein the service to be provided to the user equipment via the WWAN comprises downlink data, a mobile call, or an internet service, or a combination thereof.

16. The serving gateway as claimed in claim 8, wherein the processing circuitry is configured to otherwise page the user equipment via the WWAN if the user equipment is not capable of operating via network based internet protocol flow mobility with the network.

17. The serving gateway as claimed in claim 8, wherein the processing circuitry is configured to otherwise page the user equipment via the WWAN if the user equipment is not connected to the WLAN when the service to be provided to the user equipment is received.

18. A non-transitory storage medium comprising instructions that, if executed by a processor, result in a user equipment:
connecting to a network with a single packet data network connection over a wireless wide area network (WWAN) and a wireless local area network (WLAN);
entering an idle state for WWAN access;
receiving a page over the WLAN while in the IDLE state for WWAN access, wherein the page is for service via the WWAN;
connecting to the network via the WWAN; and
receiving the service via the WAN.

19. The storage medium as claimed in claim 18, wherein the WWAN comprises a Third Generation Partnership Project (3GPP) network.

20. The storage medium as claimed in claim 18, wherein the idle state comprises an ECM_IDLE state.

21. The storage medium as claimed in claim 18, wherein in order to connect to the network via the WWAN, the instructions, if executed by the processor, further result in the user equipment:
initiating a service request procedure over the WWAN; and
transitioning to an ECM_CONNECTED mode over the WWAN.

22. The storage medium as claimed in claim 18, wherein the instructions, if executed by the processor, further result in the user equipment:
entering into a power saving mode; and
waking in response to receiving the page over the WLAN while in the power saving mode.

23. The storage medium as claimed in claim 18, wherein the service via the WWAN comprises downlink data, a mobile call, or an internet service, or a combination thereof.

24. The storage medium as claimed in claim 18, wherein the instructions, if executed by the processor, result in the user equipment operating via network based internet protocol flow mobility with the network.

25. An article of manufacture comprising a non-transitory storage medium having instructions thereon that, if executed, result in a serving gateway:
providing a connection to user equipment (UE) over a wireless wide area network (WWAN) simultaneously with a wireless local area network (WLAN) connected to the user equipment as a single packet data network connection;
receiving a service to be provided to the user equipment over WWAN access;
paging the user equipment via the WLAN if the user equipment is in an idle state for the WWAN;
connecting with the user equipment via the WWAN after receiving a response from the user equipment; and
providing the service to the user equipment via the WWAN.

26. The article of manufacture as claimed in claim 25, wherein the WWAN comprise a Third Generation Partnership Project (3GPP) network.

27. The article of manufacture as claimed in claim 25, wherein the serving gateway is co-located with a packet data network gateway (P-GW), and the instructions, if executed, result in the gateway sending the page to the user equipment via the packet data network gateway.

28. The article of manufacture as claimed in claim 25, wherein in order to page the user equipment, the instructions, if executed, result in the serving gateway causing a Wireless Local Area Network (LAN) Control Plane (WLCP) paging request to be sent to the user equipment and to receive a WLCP paging response from the user equipment.

29. The article of manufacture as claimed in claim 25, wherein in order to page the user equipment, the instructions, if executed, result in the serving gateway causing an IKEv2 INFORMATIONAL Request which includes a paging request to be sent to the user equipment and to receive a IKEv2 INFORMATIONAL Response which includes a paging response from the user equipment.

30. The article of manufacture as claimed in claim 25, wherein in order to page the user equipment, the instructions, if executed, result in the serving gateway sending a notification to a trusted wireless access gateway (TWAG) of the WLAN and to receive a notification response back from the trusted wireless access gateway.

31. The article of manufacture as claimed in claim 25, wherein the response received from the user equipment comprises a service request for WWAN access.

32. The article of manufacture as claimed in claim 25, wherein the service to be provided to the user equipment via the WWAN comprises downlink data, a mobile call, or an internet service, or a combination thereof.

33. The article of manufacture as claimed in claim 25, wherein the instructions, if executed, result in the serving gateway otherwise paging the user equipment via the WWAN if the user equipment is not capable of operating via network based internet protocol flow mobility with the network.

34. The article of manufacture as claimed in claim 25, wherein the instructions, if executed, result in the serving gateway otherwise paging the user equipment via the WWAN if the user equipment is not connected to the WLAN when the service to be provided to the user equipment is received.
